(19) United States
(12) Patent Application Publication
(10) Pub. No.: US 2023/0138938 A1
(43) Pub. Date: May 4, 2023

(54) BANKNOTE SORTER AND CONTROLLING METHOD THEREOF

(71) Applicants: Kyu Ho LEE, Seoul (KR); Kwang Yong SHIN, Seoul (KR); Jun Woo JUNG, Sungnam-si (KR)

(72) Inventors: Kyu Ho LEE, Seoul (KR); Kwang Yong SHIN, Seoul (KR); Jun Woo JUNG, Sungnam-si (KR)

(73) Assignee: KISAN ELECTRONICS CO., LTD., Seoul (KR)

(21) Appl. No.: 17/748,423

(22) Filed: May 19, 2022

(30) Foreign Application Priority Data
Nov. 2, 2021 (KR) 10-2021-0149062

(51) Int. Cl. G07D 7/12; G02B 3/02; G07D 11/50; G06T 7/00

(52) U.S. Cl. CPC G07D 7/12; G02B 3/02; G07D 11/50; G06T 7/0002; G07D 2207/00; G07D 2211/00; G06T 2207/20081; H04N 1/02865

(57) ABSTRACT

Provided is a banknote sorter. A light source unit obliquely illuminates light at a designated angle onto a surface of a banknote when the banknote is being transferred through the banknote sorter by a driving means. A light sensor unit is placed to sense the light that is irradiated at the designated angle onto the surface of the banknote and/or tape, reflected from the surface of the banknote and/or the tape, and is incident onto the light sensor unit at an angle different from the designated angle. A control unit controls the light source unit, processes sensing information from the light sensor unit, and discriminates any tape on the banknote.

### CROSS REFERENCE TO RELATED APPLICATION

This application claims priority from Korean Patent Application No. 10-2021-0149062, filed on Nov. 2, 2021, which is hereby incorporated by reference for all purposes as if fully set forth herein. In addition, research in this application was supported by the SME Innovation Development Project (Project Number: 52872244) of the Ministry of SMEs and Startups in the Republic of Korea.

### FIELD

The present disclosure relates to a banknote sorter and a control method thereof, and more particularly, a banknote sorter capable of accurately determining a banknote to which tape is attached using a contrast ratio (a contrast) of light reflected from the tape and the banknote, and a control method thereof.

### DISCUSSION OF THE BACKGROUND

vTypically, banknote sorters do not only count banknotes but may also determine whether such banknotes are lawful currency, and whether the banknotes are suitable for circulation or should be discarded. For example, such banknote sorters may determine whether or not the banknotes are suitable or fit for circulating (i.e., new or clean banknotes, circulating banknotes, damaged banknotes, or the like), and whether or not the banknotes are counterfeit banknotes.

To determine a taped banknote among various banknotes in various states of damage, a roller displacement detection method, an ultrasonic transmitting method, a capacitance detection method, an ultrasonic reflection method, a fluorescent image detection method, a polarized image detection method, and the like may be used.

The roller displacement detection method is a most currently used method, but has a problem in that foreign materials attached to the banknote stick to a surface of a detection roller coming into contact with the banknote, and thus cause distortion of the roller displacement detection signal. The ultrasonic transmitting method may have problems in that it is difficult to detect tape attached to the edge of a banknote, and signal distortion can be caused from the banknote by crumpling, creases from folding, and contamination. The capacitance detection method may have a problem in that, with respect to a banknote that includes metallic banknote forgery-preventing elements, it may be difficult to detect tape adhered thereto. The ultrasonic reflection method may have problems in that it may be difficult to overcome the temperature dependence of the speed of sound and a residual vibration characteristic of the ultrasonic sensor. The fluorescent image detection method may have a problem in that it may be difficult to detect tape undergoing a weak fluorescent reaction or that fails to undergo a fluorescent reaction. The polarized image detection method may have a problem in that it may be difficult to detect tape whose surfaces are not smooth and whose mechanical design is not easy.

In this way, methods of determining existing taped banknotes (i.e., damaged or torn taped banknotes) suffer from various problems, and a method of improving these methods and overcoming these problems to allow taped banknotes to be determined at high speed is desired.

Background art that may be relevant to the present disclosure may be disclosed in Korean Patent No. 10-0812254 (registered on 03.04.2008, entitled “PAPER MONEY DETECTOR”).

### BRIEF SUMMARY

According to an aspect of the present disclosure, the present disclosure has been devised to overcome the above problems, and is directed to providing a banknote sorter capable of accurately determining a banknote to which tape is attached using a contrast ratio (a contrast) of light reflected from the tape or the banknote, and a control method thereof.

A banknote sorter according to an aspect of the present disclosure may include a light source unit configured to project light obliquely onto a surface of a banknote (e.g., that may be input into and transferred through the banknote sorter) at a first designated angle; a glass configured to allow unhindered transfer of the banknote while refracting the light from the light source unit onto the banknote; a light sensor unit configured to sense the light (e.g., which passes through the glass, is projected onto and reflected from the surface of the banknote, and passes through the glass again) that is incident at a second designated angle different from the first designated angle; and a control unit configured to control the light source unit, process sensing information from the light sensor unit, and determine whether a tape is on the banknote.

A method of controlling a banknote sorter according to another aspect of the present disclosure may include driving a light source unit to obliquely project light at a first designated angle upon a surface of a banknote in the banknote sorter using a control unit; using the control unit, obtaining a banknote surface image from the surface of the banknote through a light sensor unit receiving the light reflected from the banknote, transmitted through a glass, and incident at a second designated angle different from the first designated angle; and using the control unit, processing the banknote surface image to detect a tape region on the banknote.

A banknote sorter according to an aspect of the present disclosure may include a light source unit that generates light to be obliquely illuminated at a designated angle to a surface of a banknote in the banknote sorter (e.g., which may be transferred through the banknote sorter by driving means); a light sensor unit placed to sense the light (which may be irradiated with an inclination of the designated angle onto the surface of the banknote and/or any tape thereon) reflected from the surface of the banknote and/or any tape thereon, and incident onto the light sensor unit at an angle different from the designated angle; and a control unit that controls the light source unit, processes sensing information from the light sensor unit, and discriminates the tape (if any) on the banknote.

According to one aspect of the present disclosure, an entire surface of tape attached to a banknote may be determined using a contrast ratio (a contrast) of light reflected from the tape or the banknote, whereby which remarkably improves the accuracy of determining banknotes to which the tape is attached. Another aspect of the present disclosure simplifies the mechanical configuration for determining a banknote to which tape is attached, to cut down design and production costs.

### BRIEF DESCRIPTION OF THE DRAWINGS

The above and other objectives, features, and advantages of the present disclosure will be more clearly understood from the following detailed description, taken in conjunction with the accompanying drawings, in which:

FIG. 1 is an exemplary view illustrating a schematic configuration of a banknote sorter according to one or more embodiments of the present disclosure;

FIG. 2 is an exemplary view illustrating a schematic configuration of the banknote sorter in FIG. 1 in accordance with another embodiment of the present disclosure;

FIGS. 3A and 3B are exemplary views illustrating why and how to set a light sensor unit to receive the rays of light at a second incidence angle;

FIG. 4 is an exemplary view illustrating an image in which a taped banknote is determined by a method according to one or more embodiments of the present disclosure;

FIG. 5 is a flow chart illustrating a method of controlling the banknote sorter according to embodiments of the present disclosure.

FIGS. 6A and 6B are exemplary views conceptually illustrating basic principles of identifying a taped banknote in a banknote sorter according to one or more embodiments of the present disclosure; and

FIG. 7 is an exemplary view illustrating a basic configuration of identifying a taped banknote in a banknote sorter according to one or more embodiments of the present disclosure.

### DETAILED DESCRIPTION

For reference, a banknote sorter described in an embodiment according to the present disclosure is used with a conceptual meaning encompassing all various banknote processing apparatuses and systems having one or more functions including recognizing various denominations of banknotes (e.g., $10, $50, $100, ¥10, ¥100, €5, €10, etc.), determining whether banknotes are counterfeit or forged, counting the number of banknotes, determining whether banknotes are fit or unfit for circulation (e.g., depending on the degree of damage such as scribbling, contamination, tearing, or the like), and recognizing serial numbers of the banknotes.

It is noted that the banknote sorter herein can process various types of paper media such as checks, valuable documents, gift certificates, coupons and tickets, as well as banknotes. The banknote sorter is used in places in which a large quantity of banknotes, checks, valuable documents (e.g., merchandise bonds), gift certificates, etc. are circulated, including financial institutions such as bank branches, post offices, money exchange offices, cash-in-transit (CIT) companies, gas stations, amusement parks, restaurants, hotels, department stores, supermarkets, duty-free shops, large retailers, convenience stores, and so on.

Such a banknote sorter is exported to various districts or countries around the world without limit to any district or country, and may be installed and operated there. In the case in which the banknote sorter is installed and operated in the actual place, the banknote sorter can handle various states of banknotes (e.g., new or clean banknotes, old banknotes, crumpled banknotes, banknotes with one or more holes, torn banknotes, banknotes with writing or eternal markings thereon, forged banknotes, contaminated banknotes, discolored banknotes, taped banknotes, and so on).

Hereinafter, a description will be made of embodiments of a banknote sorter according to the present disclosure and a control method thereof with reference to the accompanying drawings. In this description, the thickness of the lines, the size, shape, and the connection relationship of the components in the drawings may be exaggerated or briefly illustrated for clarity and convenience of explanation, and may be conceptually described. In addition, the terms described below are defined in consideration of functions in the present invention, and may vary depending on the intention of the user, or the conventional practice. Therefore, definitions of these terms should be made based on the contents throughout this specification. And throughout the specification, the expressions “˜unit”, “˜er/or”, “˜device”, or the like for the components are not used to limit the present invention and refer to a unit that performs a predetermined function or processes an operation, which may be implemented by hardware, software, or a combination thereof. In addition, it is noted that the contents described for a particular embodiment may be applied to other embodiments.

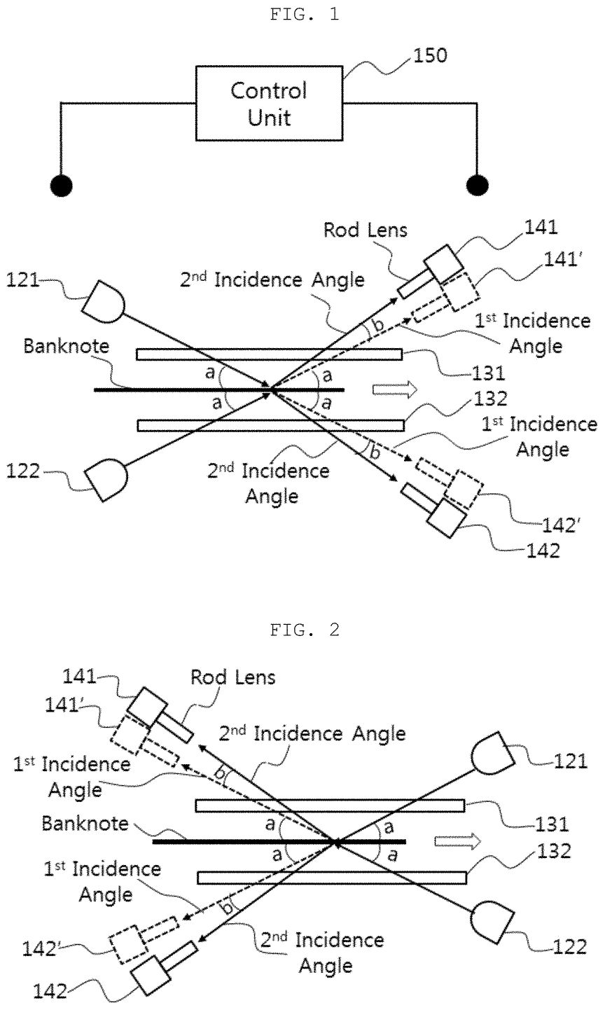

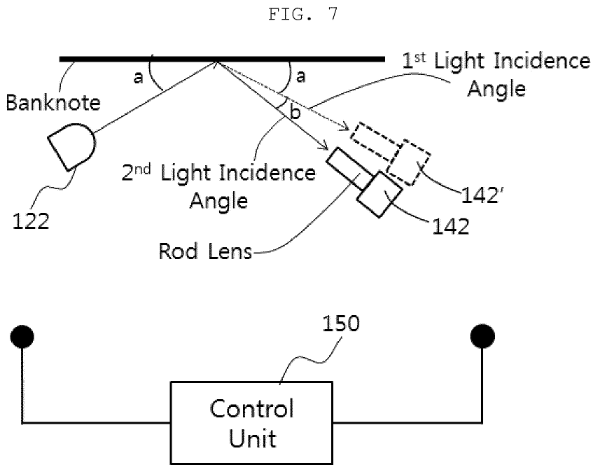

FIG. 1 exemplarily illustrates a schematic configuration of a banknote sorter according to one or more embodiments of the present disclosure, FIGS. 6A and 6B conceptually illustrate basic principles of identifying a taped banknote in a banknote sorter according to one or more embodiments of the present disclosure, and FIG. 7 exemplarily illustrates a basic configuration of identifying a taped banknote in a banknote sorter according to one or more embodiments of the present disclosure. In the embodiments below, a description will be made on a configuration and principle for determining the presence of tape on a banknote using a contrast ratio (a contrast) of light reflected from the tape or the banknote due to optical properties such as reflection, diffuse, refraction, etc. of the light that is illuminated (or projected) at an angle to a surface of the tape and/or the banknote.

First, referring to FIGS. 6A and 6B, the basic and simplified principle and concept of identifying the taped banknote in the banknote sorter according to one or more embodiments of the present disclosure will be described. A reflection image of the banknote is made by receiving and processing the light (ray) which is illuminated at an angle or in a direction inclined to a surface of the banknote and reflected from the surface of the banknote in the banknote sorter. The present invention is based on the fact that the larger the contrast difference (gap) between banknote and tape regions according to a difference in light reflection brightness between the banknote and tape regions, the better the tape region identification in the reflected image of the banknote obtained in the banknote sorter, as shown in FIG. 6A. When the contrast difference is large, the banknote region is sensed to be darker or less bright than the tape region, and the tape region is sensed to be brighter than the banknote region.

The present invention makes the contrast ratio difference between the tape and banknote regions larger (e.g., as large as possible). Referring to FIG. 6B, a line-array-type light source in which a plurality (e.g., dozens) of LEDs are arranged in a row, or a single light source such as a flashlight, illuminates or irradiates an object with light, and a light receiving sensor receives the light. When the light is received (or received after being reflected), as shown in FIG. 6B, there is a brightest area and one or more less bright areas on the light receiving side. The brightest area is the focused center region of the received light (that is, the region of the centerline of the light), and the less bright area is the region around the centerline of the receiving light (that is, the area[s] of light slightly off or misaligned with the centerline of the receiving light). The present inventors have found that placing the light receiving sensor in the brightest area to receive the brightest light does not make the contrast difference between the tape and banknote regions larger, as a result of some tests. Rather, the present inventors have found that when placing the light receiving sensor in a less bright area to receive less bright light, the contrast difference between the tape and banknote regions become much larger, and it is easier to identify the tape region (which is sensed more brightly) than the banknote region. Herein, a first light incidence angle may refer to an angle or position of the light receiving sensor in the brightest area at which the brightest ray is received (that is, the centerline of the light), and a second light incidence angle may refer to an angle or position of the light receiving sensor in a less bright area at which less bright rays are received (that is, the light slightly off or misaligned with the centerline light).

Now, referring to FIG. 7, a banknote sorter according to one or more embodiments of the present disclosure includes a light source unit 122 that generates light (e.g., a beam) to be obliquely projected (illuminated) at a designated angle “a” onto a surface of a banknote in the banknote sorter (which may be transferred through the banknote sorter by a driving means, such as a motor, a roller, etc.), a light sensor unit 142 placed to sense the light that is irradiated at the designated angle “a” to the surface of the banknote and/or tape, reflected from the surface of the banknote and/or tape, and is incident onto the light sensor unit 142 at an angle “a+b” greater than the designated angle “a” or “a−b” less than the designated angle “a”, and a control unit 150 that controls the light source unit 122, processes sensing information from the light sensor unit 142, and discriminates any tape on the banknote. Such placement of the light sensor unit 142 increases the contrast difference between the tape and banknote regions.

Herein, the light is illuminated onto the banknote at an angle of “a” degrees, and is reflected from the banknote and incident into the light sensor unit 142 at an angle of “a+b” or “a−b” degrees, which is a second light incidence angle. The sensor unit 142 is placed in a position to receive the light incident at the second light incidence angle, in the less bright area, receiving the less bright light. That is, the second light incidence angle may be a misaligned angle of the light, off the centerline of the light, rather than the angle aligned with the centerline of the light. The light illuminated and reflected at an angle of “a” degrees is a first light incidence angle, in the brightest area receiving the brightest light (that is, an angle aligned with the centerline of the incident light). The first light incidence angle may also be an aligned angle.

In addition, it is preferable that the angle “a” has a value in a range from 15° to 50°, and it is further preferable that the angle “a” has a value in the range from 30° to 40°. The tape region detection effect is better when the angle “a” is relatively small. However, if the angle “a” is too small, it becomes difficult to position the light source unit 122 and the light sensor unit 142 in the banknote sorter (e.g., in a tape sensing module [not shown] in the banknote sorter). Alternatively, the light source unit 121 can be moved further to the left in the case of FIG. 7, which may result in at least one larger dimension of the module, and thus the volume of the module increases, which may not be efficient for miniaturizing or simplifying the banknote sorter. The angle “b” can be determined depending on the value of the angle “a”, or can be set to be a predetermined angle preferable to sense the less bright light in the less bright area, in which the contrast difference between the banknote and tape regions is larger than in the brightest area. And, if the angle “a” becomes too large (for example, larger than 50 degrees), it is hard to realize a contrast difference between the banknote and tape regions, because both the banknote and tape regions are sensed to be bright. Also, at such large angles, the less bright area becomes relatively narrow, so the angle “b” is also small, in which case it is difficult to place the light sensor unit 142 accurately in a position to sense the light at the second light incidence angle. In the second light incidence angle “a±b,” “a+b” may be preferred over “a−b,” because when the second light incidence angle is less than “a,” it may be challenging to reduce or minimize the size of the tape detection hardware and/or module (see the discussion below relating to the “Moving” embodiments shown in FIG. 3B). However, the second light incidence angle “a−b” has the same effect as the second light incidence angle “a+b,” and when there are fewer restrictions on the dimensions of the tape detection module or spacing of the tape detection hardware (e.g., as in large-sized cash handling machines, or bank sorters that transfer banknotes that are not restricted by the minimum distance between rollers that must grasp opposite ends of the smallest banknote when transferring the banknote through the sorter), then the second light incidence angle “a−b” may be favorable. In some embodiments including two light sensor units, one light sensor unit may have a second light incidence angle “a+b” and the other light sensor unit may have a second light incidence angle “a−b.” In general, “b” may be any value in the range of 1-15° (e.g., 3-10°), but the invention is not limited to such ranges.

Now, embodiments of a banknote sorter according to the present invention illustrated in FIG. 1 will be described. As in FIG. 1, the banknote sorter includes light source units 121 and 122, glasses 131 and 132, light sensor units 141 and 142, and a control unit 150. The light source units 121 and 122 generate light (e.g., light beams) to be obliquely projected (illuminated) at designated angles “a” onto upper and lower surfaces (or which may be referred to as first and second surfaces, or front and rear surfaces, etc.) of a banknote in the banknote sorter (which may be transferred through the banknote sorter by driving means, such as a motor, a roller, etc.). The glasses 131 and 132 enable the banknote to be transferred smoothly (e.g., without being hindered) and refract the light from the light source units 121 and 122 illuminated (projected) toward the upper and lower surfaces of the banknote. The light sensor units 141 and 142 detect the light that has penetrated the glasses 131 and 132, illuminated the upper and lower surfaces of the banknote at the designated angle “a,” and been reflected from the upper and lower surfaces of the banknote at designated upper and lower angles of “a+b” or “a−b” (at a second light incidence angle different from a first light incidence angle corresponding to the angle “a”). The control unit 150 controls the light source units 121 and 122, processes sensing information from the light sensor units 141 and 142, and discriminates any tape on the banknote (e.g., from the banknote itself).

Meanwhile, rod lenses may be in front of the light sensor units 141 and 142, or be integral (e.g., formed as a single unit) with the light sensor units 141 and 142.

Further, the glasses 131 and 132 may have a designated thickness (e.g., 1.1 mm, 1.8 mm, etc.), and the thickness of the glasses 131 and 132 may change to adjust the angles of light incident upon the light sensor units 141 and 142 (or the reflection angles from the banknote) (see \textcircled{1} “Glass Change” in FIG. 3B). The glasses 131 and 132 may comprise a glass (e.g., a doped or undoped silicate or aluminosilicate), or any other material that is excellent in transmissivity of the light. The glasses 131 and 132 may contain a substance or have a composition ratio optimized for a particular environment, or for implementation of the invention.

The light sensor units 141 and 142 are placed to receive the light at second incidence angles “a+b” and/or “a−b” (i.e., angles that deviate by “b” from the centerline of the banknote/tape light reflection angles to form the less bright area[s], or hereinafter referred to as misalignment angles) rather than first incidence angles “a” (i.e., angles at which the centerline of the light forms the brightest area, hereinafter referred to as alignment angles). As described above, the position of the light sensor units 141′ and 142′ placed to receive the light at the first incidence angles “a” is difficult to expect the effects of the present invention, because the contrast difference between the banknote and tape regions are relatively small.

For example, a method in which the incidence angles of the light on the light sensor units 141 and 142 after being reflected from the banknote (or the tape) and then passing through the glass 131 or 132 are the second incidence angles “a+b” and/or “a−b” may comprise (as illustrated in FIG. 3B) replacing the glass(es) 131 and/or 132 with a glass having a designated specific (different) thickness displacing (moving) a position of the light source unit(s) 121 and/or 122 (e.g., by increasing or reducing the distance between the light source unit[s] 121 and/or 122 and the corresponding glass[es] 131 and/or 132), or displacing (moving) a position of the light sensor unit[s] 141 and/or 142 to change the designated angle “a+b” and/or “a−b” (e.g., by adjusting the distance of the light sensor unit[s] 141 and/or 142 from the corresponding glass[es] 131 and/or 132; see \textcircled{2} “Moving” in FIG. 3B).

In the embodiments described above, the reason why the incidence angles of the light on the light sensor units 141 and 142 after being reflected from the banknote (or the tape) and then passing through or being refracted by the glasses 131 and 132 are the second incidence angles “a+b” and/or “a−b” (or misalignment angles) is that, when sensing the taped banknote using the light sensor units 141 and 142 at second incidence angles “a+b” (or misalignment angles), the light reflected from the banknote (or the tape) has an effect that, due to the contrast ratio (the contrast) of the reflected light, the tape is sensed much more brightly than the banknote region (e.g., such that the banknote region is dark and the tape region is bright).

Further, each of the light sensor units 141 and 142 includes a contact image sensor (CIS). For example, the light source units 121 and 122 may comprise a line array of a plurality (e.g., dozens) of LEDs that emit hundreds of light pulses a second, and the light sensor units 141 and 142 scan and sense such light pulses hundreds of times per second to obtain an image with a resolution of at least dozens of dots per inch (dpi) or more. The control unit 150 identifies the tape region by processing the image and identifying a relatively bright region (see, e.g., FIG. 6A).

Further, the light source units 121 and 122 may comprise a plurality of illuminators (e.g., LEDs) in a longitudinal direction at a preset interval (e.g., spaced equally apart in a row), and the illuminators (e.g., LEDs) of the light source units 121 and 122 may irradiate light of at least one wavelength band (e.g., red light, green light, blue light, yellow light, white light, ultraviolet [UV] light, or infrared [IR] light) within a range of wavelength bands of visible light, ultraviolet light, or infrared light.

Although not illustrated in detail in the drawings, an irradiation angle adjusting member (not illustrated) for adjusting an illuminated (projected) angle of light from each of the light source units 121 and 122 may be in front of or on a front surface of each of the light source units 121 and 122.

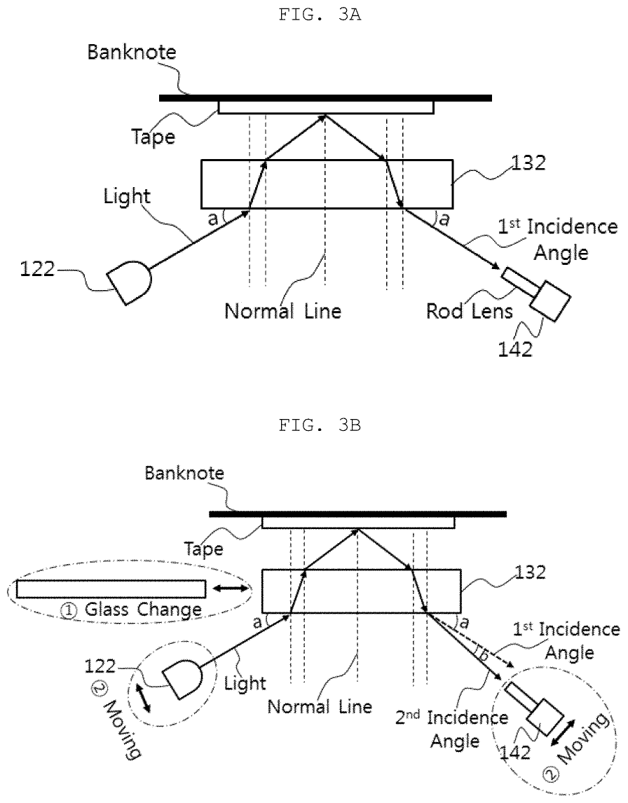

FIG. 2 is an exemplary view illustrating a schematic configuration of the banknote sorter of FIG. 1 according to another embodiment of the present disclosure. In FIG. 1, although the light source units 121 and 122 are ahead of the light sensor units 141 and 142 in the direction that the banknote travels, as illustrated in FIG. 2, the light sensor units 141 and 142 may be ahead of the light source units 121 and 122 in the direction in which the banknote travels.

That is, as illustrated in FIGS. 1 and 2, regardless of the front and rear positions of the light source units 121 and 122 or the light sensor units 141 and 142, the light sensor units 141 and 142 are set (placed) to receive light at second incidence angles “a+b” and/or “a−b” after the light is reflected from the banknote or the tape (or a misalignment angle or an angle at which the incident light deviates by an angle “b” from the centerline of the light at angle “a”).

In other words, FIGS. 1 and 2 merely help understanding various forms and operations of the light source units 121 and 122 and the light sensor units 141 and 142, and they can be variously changed in terms of shape or configuration, according to a design or a model of the banknote sorter.

FIGS. 3A and 3B are example views illustrating why and how to set (place) the light sensor unit to receive the reflected light at a second incidence angle.

As illustrated in FIG. 3A, in the case in which the light from the light source unit 122 is obliquely illuminated to the banknote at a designated angle “a” (or a designated irradiation angle) as the banknote is horizontally transferred above the glass 132, the light is refracted while passing through the glass 132 and irradiates the banknote or the tape, and then light reflected from the banknote or the tape is again refracted while passing through the glass 132, and is incident upon the light sensor unit 142 at the designated angle “a” (the first incidence angle).

Here, in the case in which the light sensor unit 142 is set (placed) so that the light reflected from the banknote or the tape at the alignment angle is incident upon the front center of the light sensor unit 142, the light sensor unit 142 is set (placed) to receive the light incident at the first incidence angle (“a”). In this way, when the light sensor unit 142 receives the light at the first incidence angle “a” (or the alignment angle), it is difficult to expect the tape on the banknote to be sensed significantly more brightly than the banknote.

Thus, as illustrated in FIG. 3B, by setting (placing) the light sensor unit 142 to receive the light incident at the second incidence angle “a+b” or “a−b” (or a misalignment angle, i.e. an angle that is offset or that deviates from the centerline [i.e., the first incidence angle “a”]) after reflection from the banknote by a designated amount “b”, it is possible for the tape on the banknote to be sensed significantly more brightly than the banknote, according to any of the methods described herein (e.g., replacing the glass with a glass having a different designated specific thickness see \textcircled{1} “Glass Change” in FIG. 3B), displacing a position of or moving the light source units by increasing or reducing the distance between the light source unit and the glass, and displacing a position of or moving the light sensor unit to a designated angle of “a+b” or “a−b” by adjusting its distance from the glass [see \textcircled{2} “Moving” in FIG. 3B).

As described above, the reason why or (the principle on which) the above effect can be obtained is because a contrast difference is generated between the banknote region and the tape region according to the difference in the light reflection properties between the banknote and the tape. For example, in the case in which the light (beam) is illuminated to the taped banknote, the light is diffusely reflected from the surface of the banknote, but totally reflected from the surface of the tape. In other words, because the surface of the banknote is fibrous and may be printed with, for example, ink in a pattern, and thus is uneven and rough, light obliquely or slantedly irradiated onto the banknote surface is subject to diffuse reflection. Although there is a difference to a certain degree according to the kind or material of the tape, the tape (i.e., the surface of the tape) is more uniform and smooth than the surface of the banknote, and thus total reflection occurs from the tape surface (at least to a much greater degree than the surface of the banknote, when irradiated at an oblique angle).

In this case, the light source units 121 and 122 are at positions separated by designated distances (e.g., from 5 mm to 9 mm) from the glasses 131 and 132 to illuminate the light at an angle “a” to the banknote, thereby making it possible to further expect the effect caused by the contrast difference (i.e., the effect in which the tape on the banknote is sensed more brightly than the banknote).

FIG. 4 is an exemplary view illustrating an image from a taped banknote obtained by a method according to the present disclosure. As illustrated in FIGS. 4A and 4B, as a result of conducting a test on the effects according to the present method, it is possible to obtain nearly the same degree of contrast ratio with respect to all test light sources, regardless of the wavelength band of the light. Further, both a glossy tape (from which total reflection is observed) and a matte tape (from which diffuse reflection is observed) can produce an image having a noticeably different brightness from the banknote. Further, according to the test(s), a fluorescent tape can produce an image having an even more distinct difference when UV light is illuminated onto the taped banknote.

The above description has been made of an effect in which the light sensor unit 142 is set (placed) to receive light incident at a second incidence angle “a+b” or “a−b” (or a misalignment angle) so that the tape on the banknote is sensed more brightly than the banknote, in comparison to a first incidence angle “a” (or an alignment angle).

Hereinafter, description will be made to a method of determining the taped region on the banknote on the basis of the effect caused by a difference in the above-mentioned contrast ratio (i.e., an effect in which the tape on the banknote is sensed more brightly than the banknote).

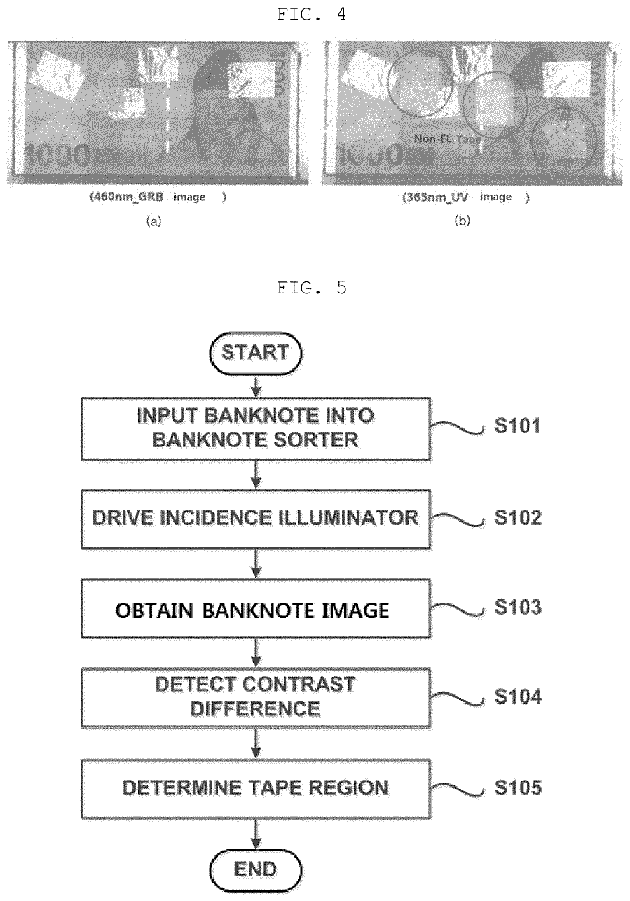

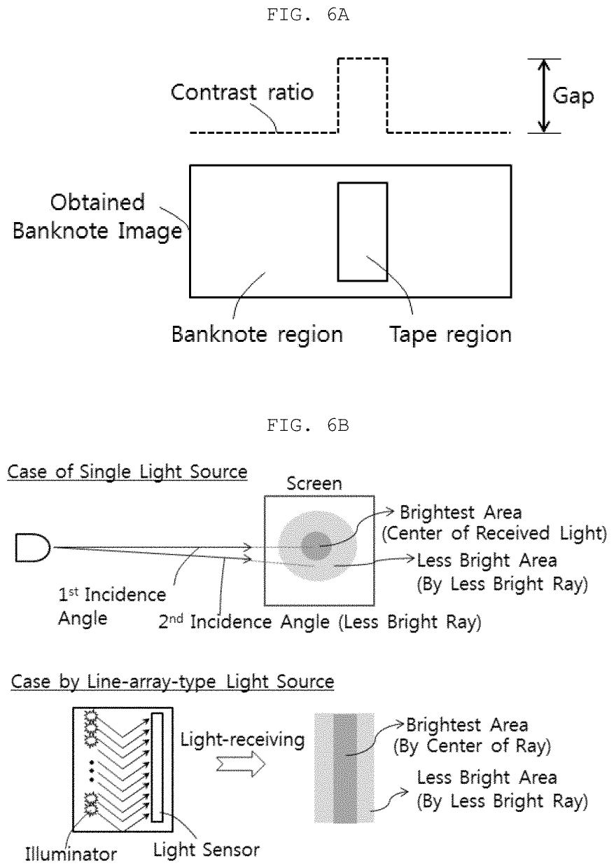

FIG. 5 is a flow chart illustrating a method of controlling a banknote sorter according to embodiments of the present disclosure.

Referring to FIG. 5, when the banknote is input (inserted) into the banknote sorter (S101), the control unit 150 drives incidence illuminators (e.g., illuminators that irradiate or project light onto a banknote surface at an oblique angle according to the type of light source or irradiator) (S102).

Here, as illustrated in FIGS. 1 to 3B, lateral (side) incidence illuminators such as the light source unit 121 and 122 generate light projected (irradiated) at designated angles “a” onto the upper and/or lower surfaces of the transferring banknote. As the light source unit 121 and 122 are driven by the control unit 150, the light (e.g., light beams) from the light source unit 121 and 122 penetrates the glasses 131 and 132 at designated angles “a”, is reflected from the banknote (or the tape), again penetrates the glasses 131 and 132, and is incident upon the light sensor unit 141 or 142 at a second incidence angle “a+b” and/or “a−b” (or a misalignment angle).

Thus, the control unit 150 produces a banknote image (i.e., banknote surface images) using data from the light sensor units 141 and 142 at designated angles or positions above and/or below the banknote (i.e., the light sensor units set or placed such that light reflected from the banknote through the glass[es] is incident at a second incidence angle “a+b” and/or “a−b”) (S103).

Further, when the control unit 150 processes the obtained banknote images (i.e., banknote surface images) in which a contrast difference generated by the aforementioned effect according to the present disclosure is detected (i.e., the effect that the tape on the banknote is brighter than the banknote) (S104) (e.g., the tape region is detected to be bright, and the banknote region is detected to be dark or less bright), the tape on the banknote is determined (discriminated) (S105). When the control unit 150 does not determine a contrast difference on an image of the banknote, then it is determined that tape is not on the banknote.

In this case, the detection (determination) of the tape region can be performed on the basis of (e.g., in comparison with) several normal (e.g., untaped) banknote templates. However, when the tape region is detected (e.g., on the basis of or with use of a deep learning model generated from performing deep learning while variously changing a position and shape of tape attached to the banknote and a status condition of the banknote), performance of the present invention further improves.

As described above, the present embodiments improve solutions to the existing problems. The present disclosure has been described with reference to embodiments illustrated in the drawings, which are merely illustrative. Those having ordinary skill in the art understand that various modifications and equivalent embodiments are possible. Therefore, the protection or scope of the present disclosure should be defined by the following claims.

What is claimed is:

1. A banknote sorter comprising:
a light source unit configured to project light obliquely onto a surface of a banknote at a first designated angle;
a glass configured to allow unhindered transfer of the banknote while refracting the light from the light source unit onto the banknote;
a light sensor unit configured to sense the light reflected from the banknote that is incident at a second designated angle different from the first designated angle; and
a control unit configured to control the light source unit, process sensing information from the light sensor unit, and determine whether a tape is on the banknote.

2. The banknote sorter of claim 1, wherein the first designated angle is an angle of a centerline of the light projected onto the banknote.

3. The banknote sorter of claim 2, wherein the light sensor unit is configured:
to change or replace the glass with a second glass having a designated specified thickness different from that of the glass;
to displace or move a position of the light source unit by adjusting a distance of the light source unit from the glass; or
to displace or move the position of the light sensor unit to the second designated angle by adjusting the distance of the light sensor unit from the glass.

4. The banknote sorter of claim 1, wherein the control unit is configured such that the tape on the banknote is sensed more brightly than the banknote.

5. The banknote sorter of claim 1, wherein the light source unit projects light onto the banknote as the banknote is transferred through the banknote sorter.

6. The banknote sorter of claim 5, wherein the light source unit is ahead of the light sensor unit in a direction that the banknote travels.

7. The banknote sorter of claim 5, wherein the light sensor unit is ahead of the light source unit in a direction that the banknote travels.

8. A method of controlling a banknote sorter, the method comprising:
using a control unit, driving a light source unit to obliquely project light at a first designated angle upon a surface of a banknote;
using the control unit, obtaining a banknote surface image from the surface of the banknote through a light sensor unit receiving light reflected from the banknote and transmitted through a glass at a second designated angle different from the first designated angle; and
using the control unit, processing the banknote surface image to detect a tape region on the banknote.

9. The method of claim 8, wherein:
the first designated angle is an angle of a centerline of the light incident to the banknote, and the method further comprises receiving the light at the second designated angle in the light sensor unit.

10. The method of claim 8, further comprising changing or replacing the glass with a second glass having a designated specified thickness different from that of the glass.

11. The method of claim 8, further comprising displacing or moving a position of the light source unit by adjusting a distance of the light source unit from the glass.

12. The method of claim 8, further comprising displacing or moving a position of the light sensor unit to the second designated angle by adjusting the distance of the light sensor unit from the glass.

13. The method of claim 8, wherein processing the banknote surface image comprises detecting a relatively bright region in the banknote image relative to the banknote and identifying the relatively bright region as the tape due to a contrast ratio of the light reflected from the banknote and the light reflected from the tape, using the control unit.

14. The method of claim 8, further comprising conducting deep learning while changing a position and a shape of tape attached to the banknote and changing state conditions of the banknote using the control unit to generate a deep learning model, and detecting the tape using the deep learning model.

15. A banknote sorter comprising:
a light source unit that obliquely illuminates light at a designated angle onto a surface of a banknote;
a light sensor unit that senses light reflected from the surface of the banknote and incident onto the light sensor unit at an angle different from the designated angle; and
a control unit that controls the light source unit, processes sensing information from the light sensor unit, and discriminates any tape on the banknote.

16. The banknote sorter of claim 15, wherein the designated angle is a first light incidence angle, and the angle different from the designated angle is a second light incidence angle different from the first light incidence angle.

17. The banknote sorter of claim 15, wherein the first light incidence angle is a centerline of the light illuminated onto the surface of the banknote.
